(19) United States
(12) Patent Application Publication
(10) Pub. No.: US 2026/0092944 A1
(43) Pub. Date: Apr. 2, 2026

(54) ACCELEROMETER

(71) Applicant: AAC Kaitai Technologies (Wuhan) CO., LTD., Wuhan (CN)

(72) Inventors: Yang Li, Wuhan (CN); Shitao Yan, Wuhan (CN); Zhan Zhan, Wuhan (CN); Lingcheng Kong, Wuhan (CN); Xiao Kan, Wuhan (CN); Zhao Ma, Wuhan (CN); Shan Yang, Wuhan (CN); KahKeen Lai, Singapore (SG); Qiuyu Tan, Singapore (SG)

(21) Appl. No.: 18/969,327

(22) Filed: Dec. 5, 2024

Related U.S. Application Data
(63) Continuation of application No. PCT/CN2024/122805, filed on Sep. 30, 2024.

(51) Int. Cl. G01P 15/125; G01P 15/08

(52) U.S. Cl. CPC G01P 15/125; G01P 2015/0831

(57) ABSTRACT

The present disclosure provides an accelerometer including a base, a sensing unit arranged on the base, and two anchor points fixed to the base. The sensing unit includes: an outer coupling unit stacked on the base; two teeter-totter structures arranged on an inner side of the outer coupling unit, where the two teeter-totter structures are arranged to be in central symmetry; two inner coupling units arranged on the inner side of the outer coupling unit, where the two inner coupling units are arranged to be symmetrical about a line connecting the two anchor points; and detecting mass blocks fixed to the outer coupling unit and/or the two inner coupling units. The accelerometer further includes two out-of-plane detection devices respectively arranged at an area on the base directly facing the outer coupling unit and at an area on the base directly facing the two inner coupling units.

### CROSS REFERENCE TO RELATED APPLICATIONS

The present application is a continuation of PCT Patent Application No. PCT/CN2024/122805, filed Sep. 30, 2024, which is incorporated by reference herein in its entirety.

### TECHNICAL FIELD

The present disclosure relates to the field of micro-mechanical structure technology, and in particular to an accelerometer.

### BACKGROUND

An accelerometer is an instrument for measuring the linear acceleration of a carrier, as shown in FIG. 1. an out-of-plane accelerometer of teeter-totter type mainly includes a base (not shown), a sensing unit arranged on the base, and anchor points 201 fixed to the base and arranged at the same level as the sensing unit. The sensing unit mainly includes a torsional spring 202 fixed between the anchor points and a detecting mass block 203. When the accelerometer is subjected to out-of-plane (Z-direction) acceleration, the detecting mass block 203 (M1) asymmetric about the rotation axis 204 drives the torsional spring 202 to rotate around the rotation axis 204, causing out-of-plane displacement in the areas 205 corresponding to capacitive plates. By arranging capacitive plates above or below the areas 205 corresponding to capacitive plates, a differential capacitor is formed, and the change in acceleration can be obtained by detecting the change in capacitance. As shown in FIG. 2, due to the asymmetric structure of the accelerometer, that is, central point 206 of mass of the accelerometer is not located on the rotation axis 204, when subjected to X-direction acceleration, in-plane (X-direction) swing will occur.

Aiming at the above problems, a patent application (US20200018777A) by Murata company discloses a structure having two teeter-totter structures. The main body of the rotational detecting mass is arranged on the teeter-totter structures, and a rigid body is added externally as a coupling structure and as a linear mass. When subjected to out-of-plane acceleration, the linear mass moves linearly along an out-of-plane direction. In this structure, the detecting plates is arranged to be relatively far away from the rotational axis, ensuring the gain of change in capacitance resulting from rotation and eliminating the swing along the X-axis direction (IP1-axis direction). However, it cannot suppress the rotation of the two teeter-totter structures in the same direction around the Z axis (OP axis) and around the X axis (IP1 axis).

A patent application (US20200132716A1) by ADI company discloses a multi-axis accelerometer, in which the out-of-plane accelerometer has a butterfly structure, that is, the motion coupling between two teeter-totter structures is implemented using an inner coupling structure, which can suppress the in-plane rotation of a single teeter-totter structure and the rotation in the same direction around the rotation axis. Compared to the structure of Murata company, this structure has no linear detecting mass for Z-axis linear motion as an outer coupling structure, so its ability of suppressing the rotation of the two teeter-totter structures in reverse directions around the Z axis is poor.

In summary, accelerometers in related technologies are unable to convert all out-of-plane displacement of plates of a capacitor into linear displacement, resulting in poor linearity of acceleration detection of the accelerometers.

### SUMMARY

The present disclosure is intended to provide an accelerometer that improves the linearity of acceleration detection.

To this end, embodiments of the present disclosure provide an accelerometer including a base, a sensing unit arranged on the base, and two anchor points fixed to the base and arranged at a same level as the sensing unit. The two anchor points are arranged to be opposite to and apart from each other. The sensing unit includes: an outer coupling unit stacked on the base; two teeter-totter structures arranged to space apart from each other and on an inner side of the outer coupling unit, where the two teeter-totter structures are arranged to be in central symmetry; two inner coupling units arranged on the inner side of the outer coupling unit, where the two inner coupling units are arranged to be symmetrical about a line connecting the two anchor points and are respectively arranged on both sides of the two anchor points, and a teeter-totter structure of the two teeter-totter structures is elastically connected to the outer coupling unit, the two inner coupling units, and an other teeter-totter structure of the two teeter-totter structures; and detecting mass blocks fixed to the outer coupling unit and/or the two inner coupling units. The accelerometer further includes two out-of-plane detection devices respectively arranged at an area on the base directly facing the outer coupling unit and at an area on the base directly facing the two inner coupling units, and the two out-of-plane detection devices are configured to detect linear motion along a first direction generated by the outer coupling unit and/or the two inner coupling units using capacitive detection.

As an improvement, the two teeter-totter structures are arranged in a nested manner.

As an improvement, two anchor points are arranged at a middle region of the outer coupling unit.

As an improvement, the outer coupling unit includes a rectangular ring-shaped support portion, two weight portions spaced from each other, and two connecting portions configured to respectively connect the two weight portions to both sides of the support portion. The two weight portions are arranged to space apart from the support portion and the two teeter-totter structures, and the two weight portions function as the detecting mass blocks.

As an improvement, each teeter-totter structure of the two teeter-totter structures includes two respective torsional springs spaced from each other and respective elastic members respectively fixed to the two torsional springs. Two ends of the two respective torsional springs facing to each other are respectively fixed to the two anchor points, and two ends of the two respective torsional springs far away from each other are respectively connected to the elastic members. The respective elastic members of a teeter-totter structure of the two teeter-totter structures are elastically connected to the outer coupling unit, the two inner coupling units, and the respective elastic members of an other teeter-totter structure of the two teeter-totter structures, and a teeter-totter structure of the two teeter-totter structures is arranged to space apart from the outer coupling unit, the two inner coupling units, and the respective elastic members of an other teeter-totter structure of the two teeter-totter structures.

As an improvement, the respective elastic members of each teeter-totter structure of the two teeter-totter structures include: a first elastic beam and a second elastic beam respectively fixed on both sides of the two connecting portions; a rotating arm fixed to an end of the first elastic beam away from the two connecting portions; a first extension portion fixed to an end of the second elastic beam away from the two connecting portions; a fixing portion extending from the rotating arm to the first extension portion; a second extension portion protruding and extending from the rotating arm towards the first extension portion; a third elastic beam connected to an end of the rotating arm away from the first elastic beam and connected on a side of an inner coupling unit of the two inner coupling units away from the first elastic beam; a bending portion formed by bending and extending an end of the first extension portion away from the second elastic beam around an other inner coupling unit of the two inner coupling units; a fourth elastic beam connected to an end of the bending portion away from the first extension portion and connected on a side of a corresponding inner coupling unit of the two inner coupling units away from the second elastic beam; and a fifth elastic beam connected to the bending portion. The second extension portion is spaced apart from the bending portion and the fixing portion, and the fifth elastic beam is arranged between and spaced apart from the two anchor points. Two ends of the two respective torsional springs of each teeter-totter structure of the two teeter-totter structures far away from each other are respectively connected to the rotating arm and to the first extension portion, and are arranged to space apart from the fixing portion, the second extension portion, and the bending portion. Two ends of the two respective torsional springs of each teeter-totter structure of the two teeter-totter structures facing to each other are respectively fixed to the two anchor points. Fifth elastic beams of the two teeter-totter structures are connected to each other.

As an improvement, an end of each anchor point of the two anchor points away from an other anchor point of the two anchor points is connected to two corresponding torsional springs by a respective extension arm arranged between a corresponding second extension portion and a corresponding bending portion, and the respective extension arm is arranged to space apart from the corresponding second extension portion and the corresponding bending portion.

As an improvement, the base includes a base bottom and a cover covered and fixed to the base bottom, the base bottom and the cover form an accommodating space, and the sensing unit is arranged within the accommodating space. The two out-of-plane detection devices include a first capacitive plate fixed at an area of the base bottom or an area of the cover directly facing the outer coupling unit and second capacitive plates fixed at areas of the base bottom or areas of the cover directly facing the two inner coupling units.

As an improvement, the accelerometer further includes in-plane detection devices arranged on the outer coupling unit. The in-plane detection devices are configured to detect, using capacitive detection, at least one of linear motion along a second direction generated by the outer coupling unit and linear motion along a third direction generated by the outer coupling unit, and the first direction, the second direction, and the third direction are perpendicular to each other.

As an improvement, the in-plane detection devices include a plurality of X-axis in-plane detection units for detecting the linear motion along the second direction generated by the outer coupling unit, and/or a plurality of Y-axis in-plane detection units for detecting the linear motion along the third direction generated by the outer coupling unit.

Compared with the related technologies, the overall structure of the accelerometer according to the present disclosure is supported by two teeter-totter structures opposite to each other, the outer coupling structure is coupled to the outer side of the two teeter-totter structures, and the two inner coupling structures are coupled to the inner side of the two teeter-totter structures. Moreover, the two teeter-totter structures are arranged to be in central symmetry, and the two inner coupling units are arranged to be symmetrical about a line connecting the two anchor points and are respectively arranged on both sides of the two anchor points. In this way, the rotation of the two teeter-totter structures around an axis perpendicular to the plane in which the two teeter-totter structures are located can be suppressed to some extent, thereby reducing the cross coupling of the two teeter-totter structures. The detecting mass blocks of the accelerometer are arranged on the outer coupling unit and/or the two inner coupling units. When subjected to an out-of-plane acceleration along the axis perpendicular to the plane, the outer coupling unit and the inner coupling units on both sides of the teeter-totter structures move differentially relative to the base, such that the detecting capacitive plates of the out-of-plane detection devices and the sensing unit form parallel plate capacitors and undergo differential changes. In other words, when subjected to an out-of-plane acceleration, due to larger mass of the outer coupling unit, the outer coupling unit will translate in the direction of the acceleration, and the inner coupling units will translate in a direction opposite to the direction of the acceleration due to relatively small mass of the inner coupling units. Thus, the capacitance corresponding to the outer coupling unit will increase and the capacitance corresponding to the inner coupling units will decrease, thereby forming differential capacitance. In this way, the acceleration along the axis perpendicular to the plane can be detected by detecting the change in capacitance. With this structure, the displacement of the capacitive plates for out-of-plane detection can be all converted into linear displacement, thereby greatly improving the linearity of acceleration detection.

### BRIEF DESCRIPTION OF DRAWINGS

In order to illustrate the technical solutions in the embodiments of the present disclosure more clearly, the drawings to be used in the illustration of the embodiments will be briefly described below. It is obvious that the drawings mentioned in the following illustration are only some embodiments of the present disclosure. For those of ordinary skill in the art, other drawings may be obtained in accordance with these drawings without any inventive effort.

FIG. 1 is a schematic diagram of the structure of the accelerometer provided in the related technologies.

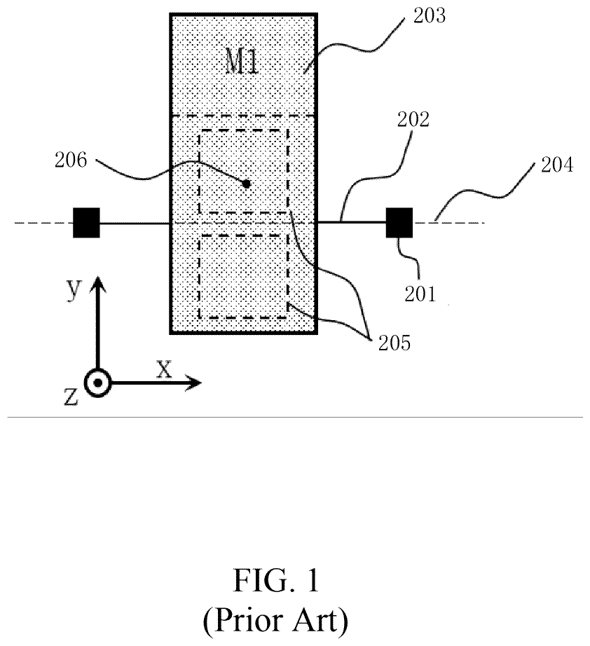

FIG. 2 is a schematic diagram of the motion state of the accelerometer provided in the related technologies.

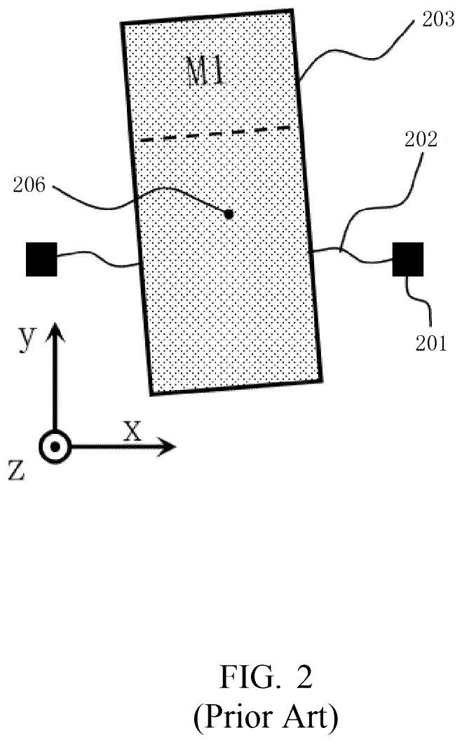

FIG. 3 is a schematic diagram of the structure of the accelerometer provided in Embodiment 1 of the present disclosure.

FIG. 4 is a schematic diagram of the detection modes of the accelerometer provided in Embodiment 1 of the present disclosure.

FIG. 5 is a schematic diagram of the modular cross-section of the accelerometer provided in Embodiment 1 of the present disclosure.

FIG. 6 is a schematic diagram of the structure of the accelerometer provided in Embodiment 2 of the present disclosure.

In the drawings: 100. accelerometer; 1. sensing unit; 11. external coupling unit; 111. support portion; 112. weight portion; 113. connecting portion; 12. teeter-totter structure; 121. torsional spring; 122. elastic member; 1221, first elastic beam; 1222. second elastic beam; 1223. rotating arm; 1224. first extension portion; 1225. fixing portion; 1226, second extension portion; 1227. third elastic beam; 1228, bending portion; 1229. fourth elastic beam; 12210. fifth elastic beam; 13. internal coupling unit; 2. anchor point; 21. extension arm; 3. in-plane detection device; 31. X-axis in-plane detection unit; 32. Y-axis in-plane detection unit; 4. base; 40. accommodating space; 41. base bottom; 42. cover; 5. first capacitive plate; 6. second capacitive plate.

### DETAILED DESCRIPTION OF EMBODIMENTS

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in the present disclosure, all other embodiments obtained by those skilled in the art without creative labor fall within the scope of protection of the present disclosure.

### Embodiment 1

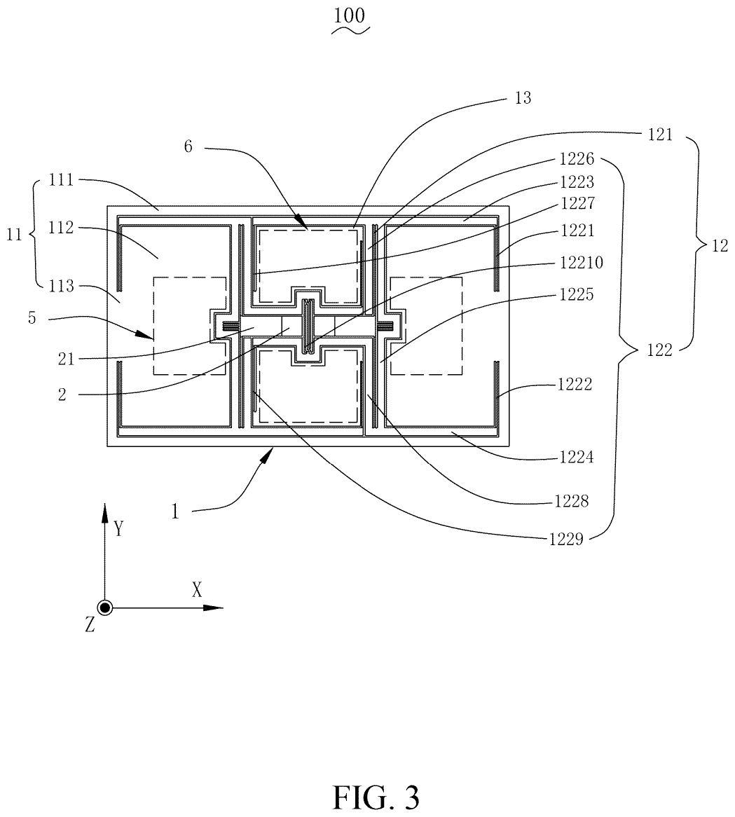

In FIG. 3, Z axis represents the first direction, X axis represents the second direction, and Y axis represents the third direction. The dashed boxes represent the areas corresponding to capacitive plates on the base 4. In conjunction with FIG. 3, embodiments of the present disclosure provide an accelerometer 100 including a base 4, a sensing unit 1 arranged on the base 4, and two anchor points 2 fixed to the base 4 and arranged at a same level as the sensing unit 1. The two anchor points 2 are arranged to be opposite to and apart from each other.

The base 4 includes a base bottom 41 and a cover 42 covered on the base bottom 41, the base bottom 41 and the cover 42 form an accommodating space, and the sensing unit 1 is arranged within the accommodating space 40.

The sensing unit 1 includes an outer coupling unit 11, two teeter-totter structures 12, two inner coupling units 13, and detecting mass blocks.

The outer coupling unit 11 is stacked on the base 4, the two teeter-totter structures 12 are arranged to space apart from each other and on an inner side of the outer coupling unit 11. The two teeter-totter structures 12 are arranged to be in central symmetry. The two inner coupling units 13 are arranged on the inner side of the outer coupling unit 11. The two inner coupling units 13 are arranged to be symmetrical about a line connecting the two anchor points 2 and are respectively arranged on both sides of the two anchor points 2, and a teeter-totter structure of the two teeter-totter structures 12 is elastically connected to the outer coupling unit 11, the two inner coupling units 13, and the other teeter-totter structure 12. The detecting mass blocks are fixed to the outer coupling unit 11 and/or the two inner coupling units 13.

The outer coupling unit 11 includes a rectangular ring-shaped support portion 111, two weight portions 112 spaced from each other, and two connecting portions 113 configured to respectively connect the two weight portions 112 to both sides of the support portion 111. The two weight portions 112 are arranged to space apart from the support portion 111 and the two teeter-totter structures 12, and the two weight portions 112 function as the detecting mass blocks. In other words, the two weight portions 112 are not only a part of the outer coupling unit 11, but also function as the detecting mass blocks.

Moreover, the support portion 111, the two weight portions 112, and the two connecting portions 113 of the outer coupling unit 11 are also a portion of the teeter-totter structures 12.

Each teeter-totter structure of the two teeter-totter structures 12 includes two respective torsional springs 121 spaced from each other and respective elastic members 122 respectively fixed to the two torsional springs 121. Two ends of the two respective torsional springs 121 facing to each other are respectively fixed to the two anchor points 2, and two ends of the two respective torsional springs 121 far away from each other are respectively connected to the respective elastic members 122. The respective elastic members 122 of a teeter-totter structure of the two teeter-totter structures 122 are elastically connected to the outer coupling unit 11, the two inner coupling units 13, and the respective elastic members 122 of the other teeter-totter structure 12. A teeter-totter structure of the two teeter-totter structures 12 is arranged to space apart from the outer coupling unit 11, the two inner coupling units 13, and the respective elastic members 122 of the other teeter-totter structure 12.

The respective elastic members 122 of each teeter-totter structure of the two teeter-totter structures 12 include: a first elastic beam 1221 and a second elastic beam 1222 respectively fixed on both sides of the two connecting portions 113; a rotating arm 1223 fixed to an end of the first elastic beam 1221 away from the two connecting portions 113; a first extension portion 1224 fixed to an end of the second elastic beam 1222 away from the two connecting portions 113; a fixing portion 1225 extending from the rotating arm 1223 to the first extension portion 1224; a second extension portion 1226 protruding and extending from the rotating arm 1223 towards the first extension portion 1224; a third elastic beam 1227 connected to an end of the rotating arm 1223 away from the first elastic beam 1221 and connected on a side of an inner coupling unit of the two inner coupling units 13 away from the first elastic beam 1221; a bending portion 1228 formed by bending and extending an end of the first extension portion 1224 away from the second elastic beam 1222 around the other inner coupling unit of the two inner coupling units 13; a fourth elastic beam 1229 connected to an end of the bending portion 1228 away from the first extension portion 1224 and connected on a side of a corresponding inner coupling unit of the two inner coupling units 13 away from the second elastic beam 1222; and a fifth elastic beam 12210 connected to the bending portion 1228. The second extension portion 1226 is spaced apart from the bending portion 1228 and the fixing portion 1225, and the fifth elastic beam 12210 is arranged between and spaced apart from the two anchor points 2. Two ends of the two respective torsional springs 121 of each teeter-totter structure of the two teeter-totter structures 12 far away from each other are respectively connected to the rotating arm 1223 and to the first extension portion 1224, and are arranged to space apart from the fixing portion 1225, the second extension portion 1226, and the bending portion 1228. Two ends of the two respective torsional springs 121 of each teeter-totter structure of the two teeter-totter structures 12 facing to each other are respectively fixed to the two anchor points 2. Fifth elastic beams 12210 of the two teeter-totter structures 12 are connected to each other.

An end of each anchor point of the two anchor points 2 away from the other anchor point 2 is connected to two corresponding torsional springs 121 by a respective extension arm 21 arranged between a corresponding second extension portion 1226 and a corresponding bending portion 1228, and the respective extension arm 21 is arranged to space apart from the corresponding second extension portion 1226 and the corresponding bending portion 1228.

In this embodiment, each teeter-totter structure of the two teeter-totter structures 12 is arranged in a nested manner. In other words, each teeter-totter structure is inserted between the outer coupling unit 11 and the inner coupling units 13. In this way, the remaining translational and rotational modes of the teeter-totter structures can be suppressed to prevent the influence of any angular velocity.

In this embodiment, the two anchor points 2 are arranged at a middle region of the outer coupling unit 11. This structural design can reduce the stress impact during the manufacturing and also can reduce fabrication errors.

The accelerometer 100 further includes two out-of-plane detection devices respectively arranged at an area on the base 4 directly facing the outer coupling unit 11 and at an area on the base 4 directly facing the two inner coupling units 13, and the two out-of-plane detection devices are configured to detect linear motion along the first direction generated by the outer coupling unit 11 and/or the two inner coupling units 13 using capacitive detection.

In this embodiment, the base 4 includes a base bottom 41 and a cover 42 covered and fixed to the base bottom 41, the base bottom 41 and the cover 42 form an accommodating space 40, and the sensing unit 1 is arranged within the accommodating space 40. The two out-of-plane detection devices include a first capacitive plate 5 fixed at an area of the base bottom 41 or an area of the cover 42 directly facing the outer coupling unit 11 and second capacitive plates 6 fixed at areas of the base bottom 41 or areas of the cover 42 directly facing the two inner coupling units 13.

The number of the first capacitive plate 5 is the same as the number of the outer coupling unit 11, and the number of the second capacitive plates 6 is the same as the number of the inner coupling units 13.

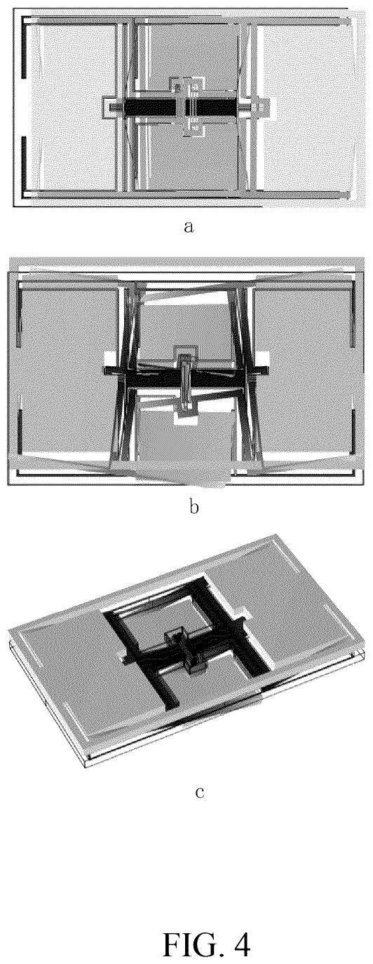

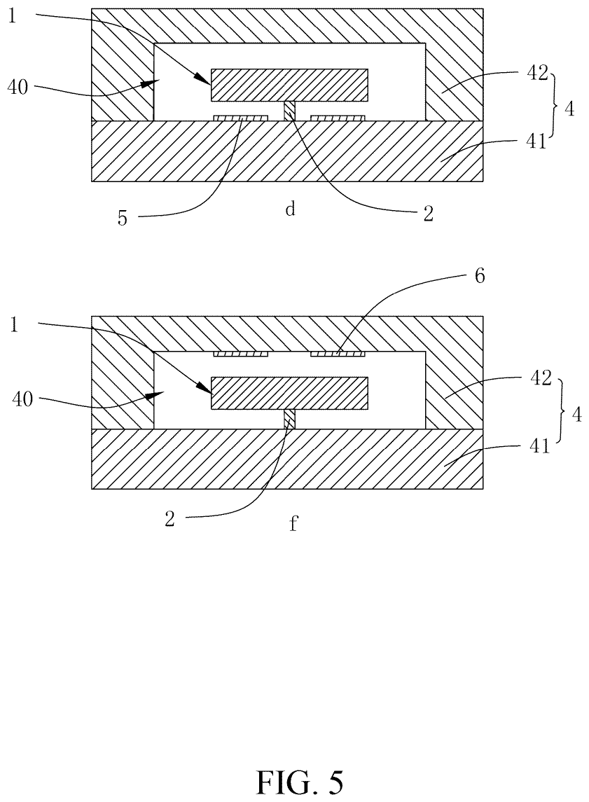

In this embodiment, various detection modes of the accelerometer 100 are shown in FIG. 4. In FIG. 4, a represents the X-axis detection mode, b represents the Y-axis detection mode, and c represents the Z-axis detection mode. In this embodiment, the modular cross-section of the accelerometer 100 is shown in FIG. 5. In FIG. 5, d represents the cross-section along X axis, showing that the first capacitive plate 5 is arranged at the area of the base bottom 41 directly facing the outer coupling unit 11; and f represents the cross-section along Y axis, showing that the second capacitive plates 6 are arranged at areas of the cover 42 directly facing the inner coupling units 13.

Compared with the related technologies, the overall structure of the accelerometer 100 in this embodiment is supported by two teeter-totter structures 12 opposite to each other, the outer coupling structure is coupled to the outer side of the two teeter-totter structures 12, and the two inner coupling structures are coupled to the inner side of the two teeter-totter structures 12. Moreover, the two teeter-totter structures 12 are arranged to be in central symmetry, and the two inner coupling units 13 are arranged to be symmetrical about a line connecting the two anchor points 2 and are respectively arranged on both sides of the two anchor points 2. In this way, the rotation of the two teeter-totter structures 12 around an axis (Z axis) perpendicular to the plane in which the two teeter-totter structures 12 are located can be suppressed to some extent, thereby reducing the cross coupling of the two teeter-totter structures 12. The detecting mass blocks of the accelerometer 100 are arranged on the outer coupling unit 11 and/or the two inner coupling units 13. When subjected to an out-of-plane acceleration along the axis perpendicular to the plane, the outer coupling unit 11 and the inner coupling units 13 on both sides of the teeter-totter structures 12 move differentially relative to the base 4, such that the detecting capacitive plates of the out-of-plane detection devices and the sensing unit 1 form parallel plate capacitors and undergo differential changes. In other words, when subjected to an out-of-plane acceleration, due to larger mass of the outer coupling unit 11, the outer coupling unit will translate in the direction of the acceleration, and the inner coupling units 13 will translate in a direction opposite to the direction of the acceleration due to relatively small mass of the inner coupling units. Thus, the capacitance corresponding to the outer coupling unit 11 will increase and the capacitance corresponding to the inner coupling units 13 will decrease, thereby forming differential capacitance. In this way, the acceleration along the axis perpendicular to the plane can be detected by detecting the change in capacitance. With this structure, the displacement of the capacitive plates for out-of-plane detection can be all converted into linear displacement, thereby greatly improving the linearity of acceleration detection.

### Embodiment 2

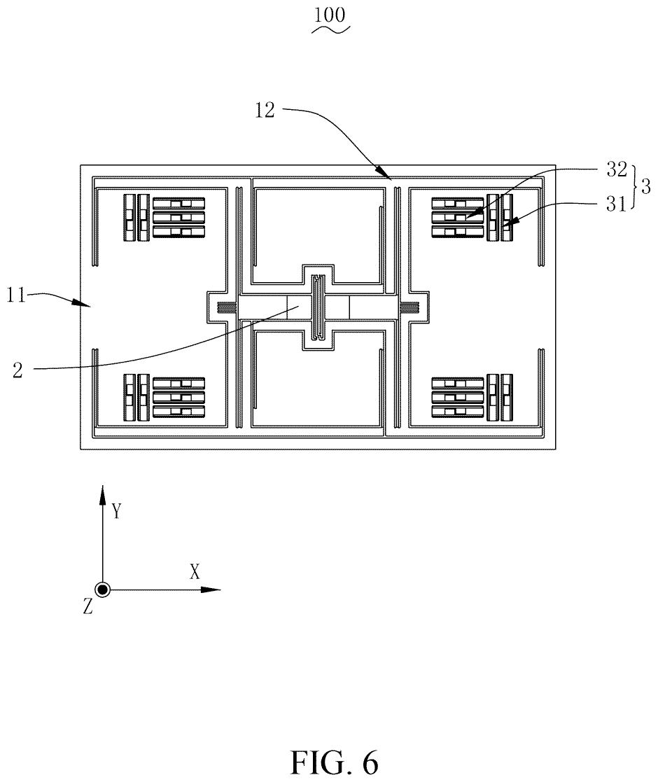

As shown in FIG. 6, in addition to the structures in Embodiment 1, the accelerometer 100 in this embodiment further includes in-plane detection devices 3 arranged on the outer coupling unit 11. The in-plane detection devices 3 are configured to detect, using capacitive detection, at least one of linear motion along the second direction generated by the outer coupling unit 11 and linear motion along the third direction generated by the outer coupling unit 11. The first direction, the second direction, and the third direction are perpendicular to each other.

The in-plane detection devices 3 include a plurality of X-axis in-plane detection units 31 for detecting the linear motion along the second direction generated by the outer coupling unit 11, and/or a plurality of Y-axis in-plane detection units 32 for detecting the linear motion along the third direction generated by the outer coupling unit 11. In this embodiment, the in-plane detection devices 3 include a plurality of X-axis in-plane detection units 31 and a plurality of Y-axis in-plane detection units 32.

The X-axis in-plane detection units 31 and the Y-axis in-plane detection units 32 in this embodiment are the same or similar to the out-of-plane detection devices in Embodiment 1, and will not be repeated here.

In this embodiment, by incorporating the X-axis in-plane detection units 31 and the Y-axis in-plane detection units 32 into the accelerometer 100, the accelerometer 100 can directly detect acceleration in three directions perpendicular to each other, thereby forming a three-axis capacitive accelerometer.

The above mentioned are only the embodiments of the present disclosure. It should be pointed out that for those skilled in the art, improvements can be made without departing from the inventive concept of the present disclosure, but these improvements are all within the scope of protection of the present disclosure.

What is claimed is:

1. An accelerometer, comprising a base, a sensing unit arranged on the base, and two anchor points fixed to the base and arranged at a same level as the sensing unit, wherein the two anchor points are arranged to be opposite to and apart from each other, and wherein the sensing unit includes:
an outer coupling unit stacked on the base;
two teeter-totter structures arranged to space apart from each other and on an inner side of the outer coupling unit, wherein the two teeter-totter structures are arranged to be in central symmetry;
two inner coupling units arranged on the inner side of the outer coupling unit, wherein the two inner coupling units are arranged to be symmetrical about a line connecting the two anchor points and are respectively arranged on both sides of the two anchor points, and a teeter-totter structure of the two teeter-totter structures is elastically connected to the outer coupling unit, the two inner coupling units, and an other teeter-totter structure of the two teeter-totter structures; and
detecting mass blocks fixed to the outer coupling unit and/or the two inner coupling units;
wherein the accelerometer further includes two out-of-plane detection devices respectively arranged at an area on the base directly facing the outer coupling unit and at an area on the base directly facing the two inner coupling units, and wherein the two out-of-plane detection devices are configured to detect linear motion along a first direction generated by the outer coupling unit and/or the two inner coupling units using capacitive detection.

2. The accelerometer according to claim 1, wherein the two teeter-totter structures are arranged in a nested manner.

3. The accelerometer according to claim 1, wherein the two anchor points are arranged at a middle region of the outer coupling unit.

4. The accelerometer according to claim 1, wherein the outer coupling unit includes a rectangular ring-shaped support portion, two weight portions spaced from each other, and two connecting portions configured to respectively connect the two weight portions to both sides of the support portion;
wherein the two weight portions are arranged to space apart from the support portion and the two teeter-totter structures, and the two weight portions function as the detecting mass blocks.

5. The accelerometer according to claim 4, wherein each teeter-totter structure of the two teeter-totter structures includes two respective torsional springs spaced from each other and respective elastic members respectively fixed to the two torsional springs;
wherein two ends of the two respective torsional springs facing to each other are respectively fixed to the two anchor points, and two ends of the two respective torsional springs far away from each other are respectively connected to the respective elastic members;
wherein the respective elastic members of a teeter-totter structure of the two teeter-totter structures are elastically connected to the outer coupling unit, the two inner coupling units, and the respective elastic members of an other teeter-totter structure of the two teeter-totter structures, and a teeter-totter structure of the two teeter-totter structures is arranged to space apart from the outer coupling unit, the two inner coupling units, and the respective elastic members of an other teeter-totter structure of the two teeter-totter structures.

6. The accelerometer according to claim 5, wherein the respective elastic members of each teeter-totter structure of the two teeter-totter structures include:
a first elastic beam and a second elastic beam respectively fixed on both sides of the two connecting portions;
a rotating arm fixed to an end of the first elastic beam away from the two connecting portions;
a first extension portion fixed to an end of the second elastic beam away from the two connecting portions;
a fixing portion extending from the rotating arm to the first extension portion;
a second extension portion protruding and extending from the rotating arm towards the first extension portion;
a third elastic beam connected to an end of the rotating arm away from the first elastic beam and connected on a side of an inner coupling unit of the two inner coupling units away from the first elastic beam;
a bending portion formed by bending and extending an end of the first extension portion away from the second elastic beam around an other inner coupling unit of the two inner coupling units;
a fourth elastic beam connected to an end of the bending portion away from the first extension portion and connected on a side of a corresponding inner coupling unit of the two inner coupling units away from the second elastic beam; and
a fifth elastic beam connected to the bending portion;
wherein the second extension portion is spaced apart from the bending portion and the fixing portion, and the fifth elastic beam is arranged between and spaced apart from the two anchor points;
wherein two ends of the two respective torsional springs of each teeter-totter structure of the two teeter-totter structures far away from each other are respectively connected to the rotating arm and to the first extension portion, and are arranged to space apart from the fixing portion, the second extension portion, and the bending portion;
wherein two ends of the two respective torsional springs of each teeter-totter structure of the two teeter-totter structures facing to each other are respectively fixed to the two anchor points; and
wherein fifth elastic beams of the two teeter-totter structures are connected to each other.

7. The accelerometer according to claim 6, wherein an end of each anchor point of the two anchor points away from an other anchor point of the two anchor points is connected to two corresponding torsional springs by a respective extension arm arranged between a corresponding second extension portion and a corresponding bending portion, and the respective extension arm is arranged to space apart from the corresponding second extension portion and the corresponding bending portion.

8. The accelerometer according to claim 1, wherein the base includes a base bottom and a cover covered and fixed to the base bottom, the base bottom and the cover form an accommodating space, and the sensing unit is arranged within the accommodating space;
the two out-of-plane detection devices include a first capacitive plate fixed at an area of the base bottom or an area of the cover directly facing the outer coupling unit and second capacitive plates fixed at areas of the base bottom or areas of the cover directly facing the two inner coupling units.

9. The accelerometer according to claim 1, further including in-plane detection devices arranged on the outer coupling unit, wherein the in-plane detection devices are configured to detect, using capacitive detection, at least one of linear motion along a second direction generated by the outer coupling unit and linear motion along a third direction generated by the outer coupling unit, and wherein the first direction, the second direction, and the third direction are perpendicular to each other.

10. The accelerometer according to claim 9, wherein the in-plane detection devices include a plurality of X-axis in-plane detection units for detecting the linear motion along the second direction generated by the outer coupling unit, and/or a plurality of Y-axis in-plane detection units for detecting the linear motion along the third direction generated by the outer coupling unit.
